(19) United States
(12) Patent Application Publication
(10) Pub. No.: US 2026/0350734 A1
(43) Pub. Date: Nov. 5, 2026

(54) Voter Verification and Polling System and Methods with Geographic Polygon Containment Authentication

(71) Applicant: Jeremiah Shank Smith, San Francisco, CA (US)

(72) Inventor: Jeremiah Shank Smith, San Francisco, CA (US)

(21) Appl. No.: 19/667,645

(22) Filed: May 4, 2026

Related U.S. Application Data
(60) Provisional application No. 63/799,039, filed on May 2, 2025.

(51) Int. Cl. G06Q 50/26

(52) U.S. Cl. CPC G06Q 50/26; G06Q 2230/00

(57) ABSTRACT

A computer-implemented system, method, and non-transitory computer-readable medium for verifying a registered voter and enabling district-exclusive verified polling. A first authentication step cross-references a user-submitted credential of a user—such as a name and address, a voter registration number, a biometric identifier, a government-issued identification document, an email address, or a phone number—against voter registration records indexed by a hashtoken in a database to identify a matched voter registration record. As a terminal step of a two-step authentication, a GPS receiver of a mobile computing device determines that geographic coordinates of the device lie within a stored geographic polygon defining a most-acutely-localized voting district associated with the matched voter registration record. Upon dual verification, a user profile is auto-populated with elected official records spanning the user's voting purview, and a district-exclusive verified poll regarding a matter within the voting purview is enabled.

### CROSS-REFERENCE TO RELATED APPLICATIONS

This application claims the benefit of priority under 35 U.S.C. § 119(e) of U.S. Provisional Patent Application Ser. No. 63/799,039, filed May 2, 2025, the entire disclosure of which is incorporated herein by reference.

### BACKGROUND OF THE INVENTION

This disclosure relates to mobile-application-based voter verification and constituent-engagement systems, and more particularly to authenticating a registered voter by cross-referencing a user-submitted credential against a voter registration record and determining whether geographic coordinates of a mobile computing device lie within a stored geographic polygon defining a most-acutely-localized voting district associated with the voter.

Voting and polling associated with elected government officials face technical challenges that undermine the accuracy and reliability of public-opinion data. Traditional telephone-based polling has become increasingly unreliable as patterns of telephone use have shifted away from landline access, and as response rates have declined sharply over time. The growth of online polling has introduced concerns associated with unverified respondents and automated participation, with reported portions of online responses suspected to be illegitimate, thereby distorting public-opinion data and reducing confidence in poll accuracy. In-person engagement formats such as town-hall meetings can be limited by organizational constraints and limited reach. These inefficiencies waste resources and erode public confidence in downstream uses of polling data, including in connection with elected officials' assessment of constituent sentiment.

Within mobile constituent-engagement applications, voter verification presents an additional set of technical challenges. Authenticating a user as a registered voter on a mobile computing device involves both (a) matching a user-submitted credential against a stored voter registration record and (b) confirming that the user is in fact the registered voter to whom the matched record pertains. Without both, user-account creation in such an application can be subject to mismatch, mistaken identity, or unauthorized registration, with attendant loss of trust in polling and constituent-connection functions provided downstream of authentication. Known approaches that authenticate based on credential matching alone, or based on coarse comparisons between a measured location and a stored address point alone, do not, by themselves, provide a second-step technical confirmation that the mobile computing device is physically situated within the boundary of the voter's voting district.

A further technical challenge arises from the geometry of voting districts themselves. Voting districts are commonly defined by non-convex, irregular polygonal boundaries. As a consequence, two adjacent residential addresses on the same street can fall in different voting districts, and a residence on one side of a street can fall in a different voting district from a residence directly across the street. A radial-distance test from a stored postal-address point—that is, an evaluation of whether a measured geographic location is within some fixed distance of a stored address point—is structurally incapable of resolving such sub-block boundary cases, because two locations that are equidistant from a given address point can lie on opposite sides of a non-convex district boundary. Confirming that a mobile computing device is physically located within a specific voting district therefore calls for a geometric containment test of the device's geographic coordinate against the stored boundary of that voting district, rather than a radial-distance test from a stored address point. This challenge persists across a wide range of mobile voter-verification and constituent-engagement contexts.

### BRIEF SUMMARY OF THE INVENTION

In one aspect, a system for verifying a registered voter and enabling district-exclusive verified polling comprises one or more processors, a memory storing instructions, a GPS receiver, a network interface, a database storing voter registration records indexed by a hashtoken, and a display device. The instructions, when executed by the one or more processors, cause the one or more processors to perform a first authentication step comprising cross-referencing a user-submitted credential of a user against the voter registration records stored in the database to identify a matched voter registration record, the user-submitted credential comprising any one of: a name and address, a voter registration number, a biometric identifier, a government-issued identification document, an email address, or a phone number; to perform, after the first authentication step and as a terminal step of a two-step authentication, a second authentication step comprising determining, using the GPS receiver, that geographic coordinates of a mobile computing device lie within a stored geographic polygon defining a most-acutely-localized voting district associated with the matched voter registration record; in response to a dual verification of the user by the first authentication step and the second authentication step, to auto-populate a user profile with elected official records of one or more voting districts within a voting purview of the user, the voting purview comprising the most-acutely-localized voting district and one or more encompassing legislative districts thereof; and, in response to the dual verification, to enable a district-exclusive verified poll regarding a matter associated with a voting district within the voting purview of the user.

In another aspect, a computer-implemented method for verifying a registered voter and enabling district-exclusive verified polling is performed by a system comprising one or more processors, a memory storing instructions, a GPS receiver, a network interface, a database storing voter registration records indexed by a hashtoken, and a display device. The method comprises performing a first authentication step comprising cross-referencing a user-submitted credential of a user against the voter registration records stored in the database to identify a matched voter registration record, the user-submitted credential comprising any one of: a name and address, a voter registration number, a biometric identifier, a government-issued identification document, an email address, or a phone number; performing, after the first authentication step and as a terminal step of a two-step authentication, a second authentication step comprising determining, using the GPS receiver, that geographic coordinates of a mobile computing device lie within a stored geographic polygon defining a most-acutely-localized voting district associated with the matched voter registration record; in response to a dual verification of the user by the first authentication step and the second authentication step, auto-populating a user profile with elected official records of one or more voting districts within a voting purview of the user, the voting purview comprising the most-acutely-localized voting district and one or more encompassing legislative districts thereof; and, in response to the dual verification, enabling a district-exclusive verified poll regarding a matter associated with a voting district within the voting purview of the user.

In a further aspect, a non-transitory computer-readable medium stores instructions that, when executed by one or more processors of a mobile computing device and one or more processors of a server in networked communication with the mobile computing device, cause the one or more processors to perform operations comprising performing a first authentication step comprising cross-referencing a user-submitted credential of a user against voter registration records stored in a database, the voter registration records being indexed by a hashtoken, to identify a matched voter registration record, the user-submitted credential comprising any one of: a name and address, a voter registration number, a biometric identifier, a government-issued identification document, an email address, or a phone number; performing, after the first authentication step and as a terminal step of a two-step authentication, a second authentication step comprising determining, using a GPS receiver of the mobile computing device, that geographic coordinates of the mobile computing device lie within a stored geographic polygon defining a most-acutely-localized voting district associated with the matched voter registration record; in response to a dual verification of the user by the first authentication step and the second authentication step, auto-populating a user profile with elected official records of one or more voting districts within a voting purview of the user, the voting purview comprising the most-acutely-localized voting district and one or more encompassing legislative districts thereof; and, in response to the dual verification, enabling a district-exclusive verified poll regarding a matter associated with a voting district within the voting purview of the user.

### BRIEF DESCRIPTION OF THE DRAWINGS

FIG. 1 illustrates a high level diagram of internet-connected components in a voter verification and polling system in accordance with an embodiment of the present disclosure.

FIG. 2 illustrates a flowchart outlining user account creation via a mobile application for a voter verification and polling system in accordance with an embodiment of the present disclosure.

FIG. 3 illustrates a flowchart outlining active user account activities engaged in via a mobile application in a voter verification and polling system in accordance with an embodiment of the present disclosure.

FIG. 4 depicts a geographic polygon containment check performed during the second authentication step of a voter verification process in accordance with an embodiment of the present disclosure.

### DETAILED DESCRIPTION OF THE INVENTION

In the following discussion, numerous specific details are set forth to provide a thorough understanding of the disclosed subject matter. However, those skilled in the art will appreciate that the present disclosed subject matter may be practiced without such specific details. In other instances, well-known elements, processes or techniques have been briefly mentioned and not elaborated on in order not to obscure the disclosed subject matter in unnecessary detail and description. Moreover, specific details and the like may have been omitted inasmuch as such details are not deemed necessary to obtain a complete understanding of the disclosed subject matter, and are considered to be within the understanding of persons having ordinary skill in the relevant art.

The following lexicography is provided for clarity. As used herein, the canonical terms set forth in paragraphs [0015] through [0022] shall have the meanings expressly given. These definitions control the meaning of corresponding claim terms.

As used herein, “voting district geographic polygon” means a closed planar geometric region, defined by an ordered list of geographic coordinates corresponding to vertices of a most-acutely-localized voting district, stored in the internal database. The voting district geographic polygon is identified herein by reference numeral 300.

As used herein, “polygon boundary” means the closed perimeter of voting district geographic polygon 300, comprising the sequence of edges connecting adjacent vertices. The polygon boundary is identified herein by reference numeral 305.

As used herein, “GPS coordinate” means a latitude and longitude pair obtained from a GPS receiver representing a physical location of a mobile computing device at a specified time. The GPS coordinate is identified herein by reference numeral 310. The GPS receiver is the mobile GPS module 36 of mobile computing device 10.

As used herein, “geographic polygon containment check” means a geometric test performed by one or more processors executing instructions stored in a memory, the geometric test determining whether GPS coordinate 310 lies within voting district geographic polygon 300. The geographic polygon containment check is identified herein by reference numeral 320.

As used herein, “authentication-proceed result” means a positive result of geographic polygon containment check 320, advancing user account creation to auto-population of user profile 25. The authentication-proceed result is identified herein by reference numeral 325.

As used herein, “authentication-reject result” means a negative result of geographic polygon containment check 320, terminating user account creation. The authentication-reject result is identified herein by reference numeral 330.

As used herein, “most-acutely-localized voting district” means the smallest voting district to which a registered voter is attached for purposes of authentication, including, by way of non-limiting example, a precinct, a ward, a city council district, or a block group. The term “micro district” is used herein, in the Detailed Description only, as a parenthetical shorthand for “most-acutely-localized voting district.”

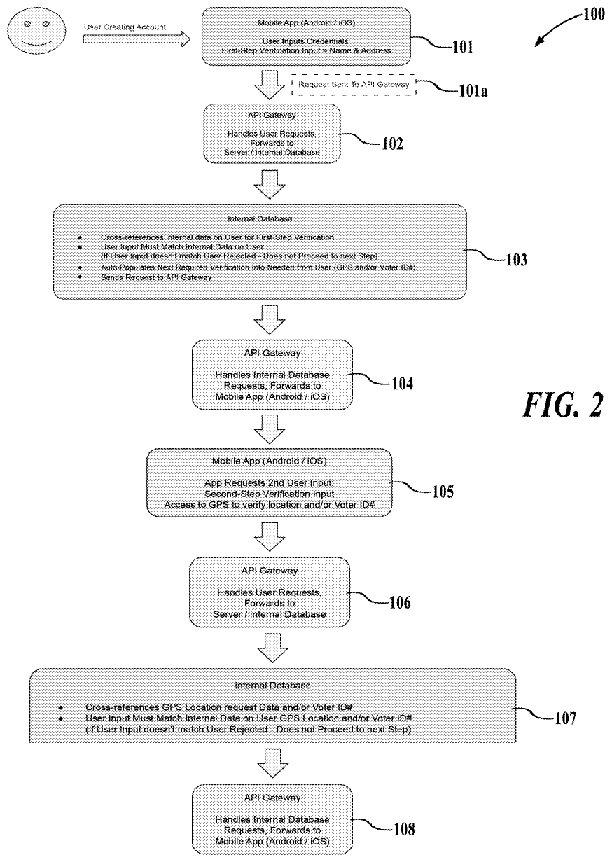

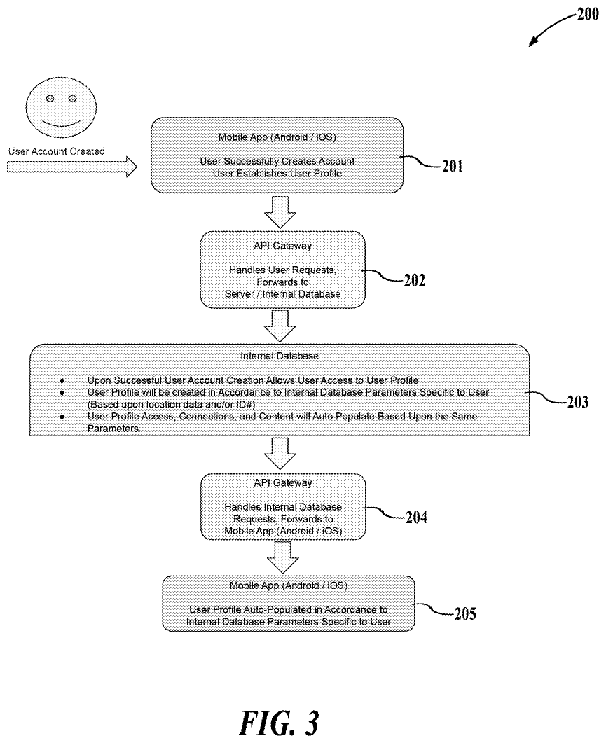

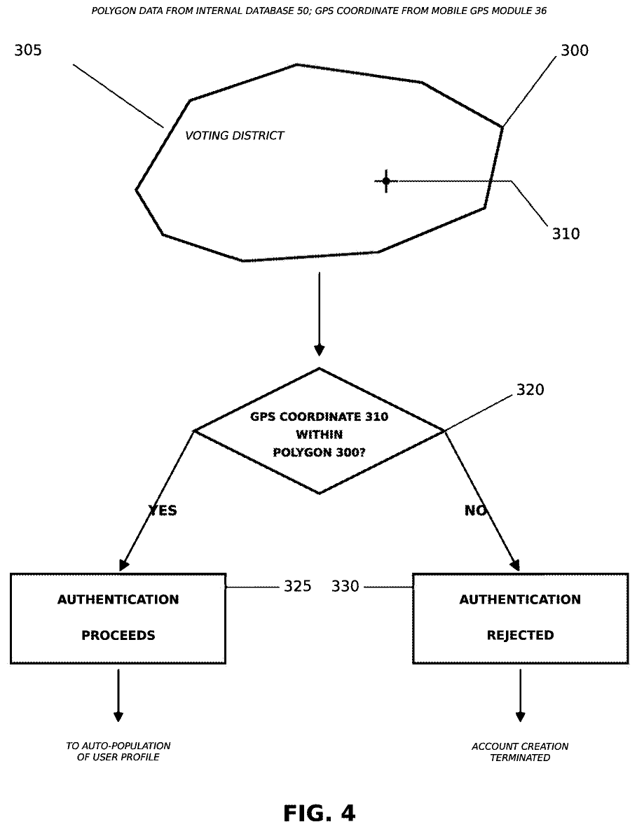

As used herein, “voting purview” means the set of voting districts to which the user belongs, comprising the most-acutely-localized voting district and one or more encompassing legislative districts thereof, including, by way of non-limiting example, a city council district, a state senate district, a state house district, a federal congressional district, federal senate seats, and executive offices. Authentication, as set forth in steps 105 and 107 of FIG. 2 and in geographic polygon containment check 320 of FIG. 4, uses solely the most-acutely-localized voting district. Auto-population of user profile 25 and access to a verified poll reach the user's full voting purview, as set forth in step 107 of FIG. 2 and step 205 of FIG. 3.

Disclosed embodiments include a mobile application that utilizes the public voter registration information of potential users to verify them as registered voters. Once verified, the mobile application automatically connects registered voters exclusively with their associated officials and representatives. The mobile application further connects representatives and officials exclusively with their constituents, allowing for direct and verified connections and verified polling between and among both registered voters and their representatives.

The present mobile application is a social networking app that focuses on establishing connections between verified registered voters and the elected representatives and officials that represent them. To further facilitate the ability of registered voters to voice their concerns, the mobile application features polling that is exclusive for each district and/or constituent bloc. Having constituents participate in polling as verified registered voters allows for a much more accurate system than the ones provided by conventional means. Moreover, it requires much less manpower, time, and resources. This may be realized through a novel verification process required for users to create an account. This verification process requires that the user is registered to vote, and that they are physically present in their voting district's geographical location when creating the user account.

Key features of disclosed embodiments include a user verification process that utilizes public registered voter information, the voter's voting district location, and the user's physical geographical location—provided by a mobile GPS module. The mobile application auto-populates various items associated with the user's voting district, and connects the user with the respective profiles of their representatives and elected officials.

For elected officials, the present system and methods provide more accurate, economical, and efficient polling, along with the ability to assess public perception. For constituents/voters, the present system and methods amplify their political voice and power through verified polling, while providing them with a badge of credibility through proper, reliable verification.

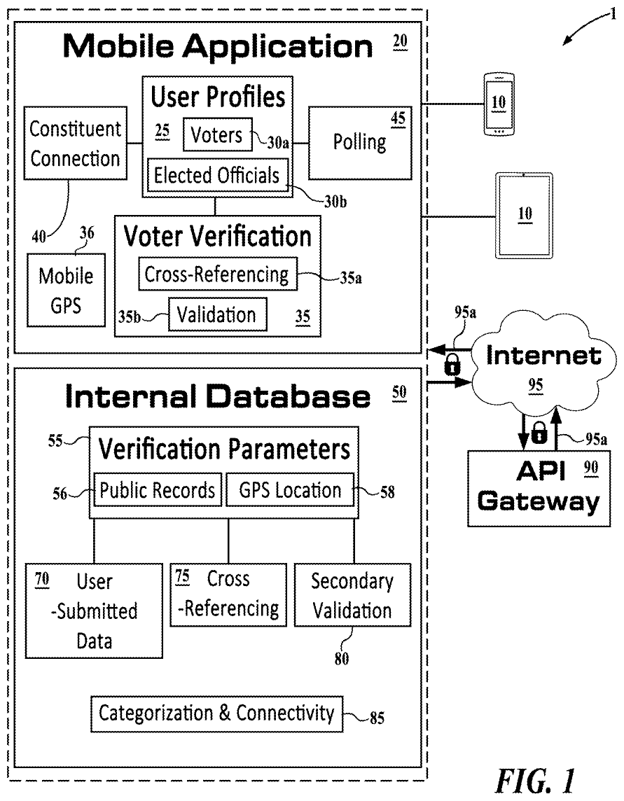

Referring to FIG. 1, a high level diagram shows internet-connected components in a voter verification and polling system 1, an exemplary system including a mobile application 20, an internal database 50 and an API gateway 90. The mobile application 20 is downloadable on a mobile computing device 10 such as a smartphone or tablet, and provides the primary source of interaction between a user and the system 1. The system 1 with mobile application 20 caters to two types of users having user profiles 25 accessible via the app 20, these being citizen voters 30a and elected officials 30b. An exemplary mobile application 20 comprises a number of modules or functions that are made active and accessible to the user after they successfully activate and log into their user profile 25. Each module or function is associated with a user interface or app screen via which the user can interact with the various modules. With regard to the mobile application 20, references to modules and functions may be interchanged with one another and with references to interfaces, since some of these modules may be functionally sourced from similarly named modules found in the internal database 50 via the internet 95 and associated cloud-computing resources such as the API gateway 90. Secure, two-way data exchange arrows 95a indicate this cloud-computing relationship.

Successful profile creation is associated with a voter verification module 35 comprising a cross-referencing function 35a and validation function 35b, these functions working in concert with a mobile GPS module 36. Mobile GPS module 36 is the GPS receiver of mobile computing device 10. Upon successful verification of the voter or user, the mobile application 20 further provides a constituent connection module 40 and a polling module 45.

Once the user is verified, they gain access to their user profile 25. The active user profile 25 is automatically populated with all of the user's associated elected officials, from state and local government to the federal level. The user gains access to their elected officials' profiles, and access to polling, via the polling module 45, for matters up for vote by their elected officials, the user having the credibility that comes with being a verified constituent, via the verification module 35, to their elected officials. Additionally, this user access is exclusive to only registered voters who are able to vote in their respective district, jurisdiction, etc., or for their respective elected official. Users do not have access to polls, elected officials, or districts outside of their respective voting purview. In one or more embodiments, the foregoing exclusivity is configurable and is reflected in the auto-population scope of user profile 25 described herein, rather than as a categorical limitation on the disclosed embodiments.

The internal database 50 provides a backend component of a macro program within the verification and polling system 1. It comprises verification parameters 55, these parameters associated with relative data. The internal database 50 stores publicly available registered voter record data 56 associated with potential users, among other stored data. Each voter record is assigned a unique identifier, such as a hashed token or alphanumeric key, that correlates to the external data sources. The unique identifier is referred to herein as a hashtoken. Voter registration inherently includes information regarding districts for which one is eligible to vote. A district represents a fixed physical geographic location 58, enclosed in a boundary, and discoverable via GPS, through the user's mobile device 10, the mobile application 20, and means known in the art. This geographic boundary is attached to a user in accordance with their most acutely localized district, or micro district. The internal database 50 also contains regularly updated data pertaining to each district's elected officials, upcoming legislative votes, polling regarding the same, and attaches relevant connections and information to users in accordance with their district and voting purview.

Verification parameters 55 operate in conjunction with user-submitted data 70 (this data submitted via the mobile app 20), a cross-referencing module 75 (for cross-referencing the user-submitted data 70 with public records 56), and a secondary validation function 80. Following verification, a categorization and connectivity module 85 provides a means for connecting verified voters 30a and their elected officials 30b. The system 1 retrieves and cross-references user-submitted information (e.g. district location, GPS location, voter ID, email, phone number, government-issued ID, biometric identifier) against corresponding public records 56.

Verification is executed via a multi-step authentication protocol, which may include user voting district location and location data from user mobile GPS 36. Users who fail verification may be prompted for secondary validation methods 80 such as security questions and manual review. Regarding automated categorization and connectivity 85, upon successful verification, the system 1 automatically assigns the user to one or more predefined categories based on stored parameters (e.g. statehouse representatives, state senators, federal house representative, federal senators, etc.). Via the categorization and connectivity module 85 the system 1 autonomously establishes connections between users who share a predefined connection based upon whether or not the user is a constituent.

The API gateway 90 acts as an intermediary primarily between the user-facing mobile application 20, and the internal database 50. The API gateway 90 translates and communicates requests to and from the database 50 and mobile application 20.

The mobile application 20 provides a user-friendly interface for sign-up and verification and seamless connection with the internal database 50. The internal database 50 stores the pre-existing user records 56 before the user signs up via the mobile application 20, and organizes users into groups based on predefined criteria. The internal database 50 provides structured memory data storage containing pre-registered user profiles prior to individual user account creation, the profile data based on public voter registration information 56.

Verification in the present system 1 provides a means for users to input information to create an account and profile 25. The mobile application 20 checks if the provided user data 70 matches the database 50. Upon a successful match, the user is authenticated and granted access. Via the automated categorization and connectivity module 85, users are automatically connected with their elected officials (other users). Matching is based upon the predefined parameters 55 in the internal database 50. Connections are instantly populated, without the need for manual searching.

Referring to FIG. 2 and FIG. 3, flowcharts outline user account creation and active user account activities engaged in via the mobile application 20. A method 100 for user account creation is initiated by user input of name and address, as indicated by step 101. The API gateway 90 then sends a request to the internal database 50 for cross-referencing, as indicated by step 102. The internal database 50 receives user input data 70 and cross-references it with internal data, i.e. public records 56, as indicated by step 103. If there is a non-match, the request is denied and the process stops. The API gateway 90 sends a request back to the user/mobile app 20, as step 104 indicates. Step 101 of FIG. 2 illustrates one species of a first authentication step in which the user-submitted credential is a name and address; in one or more embodiments, the user-submitted credential at step 101 is, in the alternative, any one of a voter registration number, a biometric identifier, a government-issued identification document, an email address, or a phone number, each of which is cross-referenced against voter registration records 56 by cross-referencing module 75 in the same manner as the name-and-address species.

The user inputs a second verification by allowing access to GPS data and/or input voter ID #, as step 105 indicates. The user is required to be physically located inside of the district boundary when creating an account, which is verified via sharing of physical location 58 via mobile GPS 36. The API gateway 90 sends a user request back to the internal database 50 for final verification and approval for account and profile creation, as indicated by step 106. The internal database 50 cross-references GPS location data to ensure that it is within the boundaries of the user's voting district and/or matches the user's voter ID #, as step 107 indicates. If approved in step 107, the internal database 50 grants access to the user and auto-populates the user's profile 25 exclusively with content and connections within their voting purview. For example, the user is connected with their state house representative, their state senators, their federal representative, their federal senators, and the U.S. president and vice president. Step 108 indicates how the API gateway then sends the request back to the mobile application 20 and user. The user thus has access to their active profile 25. The cross-referencing of GPS location data against the voting district boundary at step 107 is the terminal step of the two-step authentication and is depicted in greater detail in FIG. 4 as geographic polygon containment check 320.

A method 200 for active profile usage begins with successful active account creation via the mobile application 20, indicated by step 201. The API gateway 90 handles user requests within the mobile application 20, forwarding them to the internal database 50, as step 202 indicates. With an active profile, the user can access connections and content that populate based on the same verification parameters 55 used for user validation, as step 203 indicates. The API gateway 90 handles requests from the internal database 50, forwarding them back to the mobile application 20, as indicated by step 204. In the mobile application 20, the user profile 25 is auto-populated in accordance with parameters specific to the user, as step 205 indicates.

Referring to FIG. 4, a geographic polygon containment check 320 is depicted. Voting district geographic polygon 300 comprises a closed geometric boundary 305 defining a physical extent of a most-acutely-localized voting district, or micro district, associated with a voter registration record of the user. Polygon data defining polygon 300 is retrieved from internal database 50 via API gateway 90. GPS coordinate 310 is received from mobile GPS module 36 of mobile computing device 10, GPS coordinate 310 representing a physical location of mobile computing device 10 at a time of account creation. Containment check 320 comprises a geometric test determining whether GPS coordinate 310 lies within polygon 300.

Upon a positive determination by containment check 320, authentication proceeds 325, and the user account creation process advances to auto-population of user profile 25 in accordance with step 107 of FIG. 2. Upon a negative determination by containment check 320, authentication is rejected 330, and the account creation process is terminated.

In one or more embodiments, containment check 320 is implemented via a ray-casting algorithm, a winding-number algorithm, or another geometric containment test known in the art. In one or more embodiments, polygon 300 is defined by an ordered list of geographic coordinates corresponding to vertices of the boundary of the micro district. In one or more embodiments, the most-acutely-localized voting district associated with polygon 300 is selected from a precinct, a ward, a city council district, a block group, or another sub-jurisdictional unit within which the user is eligible to vote.

The user verification process requires that the internal database 50 contains updated voter registration data 56, that data is converted to represent the geographical location 58 of each user district such that it is readable/translatable by mobile GPS 36, and that user account creation 100 includes voter registration information 56, such as name and address, along with the user sharing GPS location while physically in the appropriate voting district. User verification requires a novel combination of public data (including name/address) that coincides with the user's respective voting district, which is verified through mobile GPS 36.

By way of non-limiting example, the ray-casting algorithm referenced in paragraph [0041] is performed by the one or more processors executing the instructions stored in the memory in accordance with the following operations: (i) defining voting district geographic polygon 300 by an ordered list of vertices V1, V2, . . . , Vn, each vertex Vi being a (latitude, longitude) pair, with edge Ei connecting Vi to Vi+1 and edge En connecting Vn to V1; (ii) receiving GPS coordinate 310 (Lat0, Lon0) from mobile GPS module 36; (iii) constructing a horizontal ray originating at GPS coordinate 310 and extending in a direction of increasing longitude to infinity; (iv) for each edge Ei of polygon boundary 305, determining whether the horizontal ray intersects edge Ei, treating an intersection at a vertex according to a consistent convention to avoid double-counting; (v) maintaining a count of the number of intersections so determined; and (vi) returning a positive determination of containment check 320 (authentication-proceed result 325) if the count is odd, and a negative determination of containment check 320 (authentication-reject result 330) if the count is even. The foregoing ray-casting algorithm is structurally capable of resolving sub-block boundary cases regardless of polygon convexity, and is one example of a containment algorithm contemplated by paragraph [0041].

By way of further non-limiting example, the winding-number algorithm referenced in paragraph [0041] is performed by the one or more processors executing the instructions stored in the memory in accordance with the following operations: (i) defining voting district geographic polygon 300 by an ordered list of vertices V1, V2, . . . , Vn as in paragraph [0043]; (ii) receiving GPS coordinate 310 from mobile GPS module 36; (iii) for each edge Ei of polygon boundary 305, computing a signed angle subtended at GPS coordinate 310 by edge Ei from Vi to Vi+1; (iv) summing the signed angles over all edges to compute a winding number; and (v) returning a positive determination of containment check 320 (authentication-proceed result 325) if the absolute value of the winding number is non-zero, and a negative determination of containment check 320 (authentication-reject result 330) if the winding number is zero.

By way of non-limiting example, the hashtoken indexing referenced in paragraph [0030] is performed by the one or more processors executing the instructions stored in the memory in accordance with the following operations: (i) for each voter registration record 56 stored in internal database 50, generating a unique identifier comprising a hashed token or an alphanumeric key, the unique identifier being a hashtoken; (ii) storing voter registration record 56 in internal database 50 as indexed by the hashtoken; (iii) upon receipt at API gateway 90 of a user-submitted credential, computing or retrieving a corresponding hashtoken and querying internal database 50 by the hashtoken to retrieve a candidate voter registration record 56; and (iv) cross-referencing the candidate voter registration record 56 against the user-submitted credential by cross-referencing module 75 to determine whether a match exists. Indexing voter registration records 56 by the hashtoken correlates each voter registration record 56 to one or more external data sources, and supports efficient retrieval, transfer, and reduced storage and processing relative to indexing by personally identifiable name-and-address strings.

By way of non-limiting example, the auto-population of user profile 25 with elected official records of one or more voting districts within the voting purview of the user, as referenced in paragraph [0029] and step 107 of FIG. 2, is performed by the one or more processors executing the instructions stored in the memory in accordance with the following operations: (i) responsive to a dual verification of the user comprising authentication-proceed result 325 of geographic polygon containment check 320, identifying, from the matched voter registration record 56, the most-acutely-localized voting district to which the user is attached; (ii) determining, from internal database 50, each encompassing legislative district that contains the most-acutely-localized voting district, including, by way of non-limiting example, a city council district, a state senate district, a state house district, a federal congressional district, federal senate seats, and executive offices, the union of these districts being the voting purview of the user; (iii) retrieving from internal database 50 the elected official record of each district within the voting purview; and (iv) populating user profile 25 with the retrieved elected official records, exclusive of any elected official, district, or poll outside the voting purview of the user.

By way of non-limiting example, the cross-referencing of a user-submitted credential against voter registration records 56 referenced in step 103 of FIG. 2 is performed by cross-referencing module 75 in accordance with the following operations: (i) receiving user-submitted data 70 from mobile application 20 via API gateway 90; (ii) parsing user-submitted data 70 to identify a credential type selected from a name and address, a voter registration number, a biometric identifier, a government-issued identification document, an email address, or a phone number; (iii) querying internal database 50 by the credential type to retrieve one or more candidate voter registration records 56; (iv) comparing the user-submitted credential against each candidate voter registration record 56 by a credential-type-specific comparison rule; and (v) returning a matched voter registration record 56 if a match is found, or a non-match result if no match is found, the non-match result causing the request to be denied and the process to stop in accordance with step 104 of FIG. 2.

In one or more embodiments, user profile 25 is configured as an anonymous-by-default profile, in which the verified-constituent status conferred by dual verification is exposed in connection with participation in a verified poll, while personally identifiable information of the user is withheld from other users of system 1, including from elected officials 30b connected to the user via categorization and connectivity module 85, unless the user affirmatively elects to disclose the personally identifiable information.

In one or more embodiments, polling module 45 is configured to receive a ternary polling response from a verified user, the ternary polling response being one of a yay response, a nay response, and an abstain response, and to record the ternary polling response in association with the matter and the voting district subject of the verified poll.

In one or more embodiments, the dual verification of the user is configured as a persistent verified state subject to periodic re-verification, in which mobile application 20 prompts the user to repeat one or both of the first authentication step of FIG. 2 and the geographic polygon containment check 320 of FIG. 4 at a configurable interval, or upon occurrence of a triggering event, including, by way of non-limiting example, expiration of a session token, a change of registered residence in voter registration records 56, or a re-installation of mobile application 20.

In one or more embodiments, the system performs a device attestation operation, in which mobile computing device 10 transmits, to API gateway 90, a hardware-backed attestation indicating that mobile application 20 is executing on a non-rooted, non-emulated mobile computing device, and the system 1 conditions advancement to geographic polygon containment check 320 on receipt of a valid hardware-backed attestation, thereby reducing susceptibility to GPS-coordinate spoofing.

In one or more embodiments, the system performs an impossible-velocity check, in which the one or more processors compute a Euclidean or great-circle distance between a GPS coordinate 310 received at a first time and a GPS coordinate 310 received at a second time, divide the distance by the elapsed time between the first time and the second time, compare the resulting velocity against a configurable threshold representing a maximum plausible velocity for human travel, and return authentication-reject result 330 if the resulting velocity exceeds the configurable threshold.

In one or more embodiments, geographic polygon containment check 320 is augmented by an altitude-bound containment, in which an altitude component of GPS coordinate 310 is compared against a configurable upper-bound altitude representing, by way of non-limiting example, a maximum residential building height for the most-acutely-localized voting district, and authentication-reject result 330 is returned if the altitude component exceeds the configurable upper-bound altitude.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

There may be many other ways to implement the disclosed embodiments. Various functions and elements described herein may be partitioned differently from those shown without departing from the scope of the disclosed embodiments. Various modifications to these implementations may be readily apparent to those skilled in the art, and generic principles defined herein may be applied to other implementations. Thus, many changes and modifications may be made to the disclosed embodiments, by one having ordinary skill in the art, without departing from the scope of the disclosed embodiments. For instance, different numbers of a given element or module may be employed, a different type or types of a given element or module may be employed, a given element or module may be added, or a given element or module may be omitted.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

The foregoing embodiments are exemplary and not limiting. Numerous variations and combinations are within the scope of the invention as defined by the claims. The operations described herein may be implemented in hardware, software, firmware, or any combination thereof. Equivalent structures, materials, acts, and steps known or later developed are within the scope of the claims.

What is claimed is:

1. A system for verifying a registered voter and enabling district-exclusive verified polling, the system comprising:
one or more processors;
a memory storing instructions;
a GPS receiver;
a network interface;
a database storing voter registration records indexed by a hashtoken; and
a display device, wherein the instructions, when executed by the one or more processors, cause the one or more processors to:
(a) perform a first authentication step comprising cross-referencing a user-submitted credential of a user against the voter registration records stored in the database to identify a matched voter registration record, the user-submitted credential comprising any one of: a name and address, a voter registration number, a biometric identifier, a government-issued identification document, an email address, or a phone number;
(b) perform, after the first authentication step and as a terminal step of a two-step authentication, a second authentication step comprising determining, using the GPS receiver, that geographic coordinates of a mobile computing device lie within a stored geographic polygon defining a most-acutely-localized voting district associated with the matched voter registration record;
(c) in response to a dual verification of the user by the first authentication step and the second authentication step, auto-populate a user profile with elected official records of one or more voting districts within a voting purview of the user, the voting purview comprising the most-acutely-localized voting district and one or more encompassing legislative districts thereof; and
(d) in response to the dual verification, enable a district-exclusive verified poll regarding a matter associated with a voting district within the voting purview of the user.

2. The system of claim 1, wherein the user-submitted credential comprises a voter registration number.

3. The system of claim 1, wherein the user-submitted credential comprises a biometric identifier.

4. The system of claim 1, wherein the user-submitted credential comprises a phone number.

5. The system of claim 1, wherein the user-submitted credential comprises a government-issued identification document.

6. The system of claim 1, wherein the second authentication step comprises applying a ray-casting algorithm to test whether the geographic coordinates of the mobile computing device lie within the stored geographic polygon.

7. The system of claim 1, wherein the second authentication step comprises applying a winding-number algorithm to test whether the geographic coordinates of the mobile computing device lie within the stored geographic polygon.

8. The system of claim 1, wherein the stored geographic polygon is defined by an ordered list of geographic coordinates corresponding to vertices of a boundary of the most-acutely-localized voting district.

9. The system of claim 1, wherein the instructions, when executed by the one or more processors, further cause the one or more processors to display, on the display device, a badge of credibility associated with the user profile in response to the dual verification.

10. A computer-implemented method for verifying a registered voter and enabling district-exclusive verified polling, the method being performed by a system comprising one or more processors, a memory storing instructions, a GPS receiver, a network interface, a database storing voter registration records indexed by a hashtoken, and a display device, the method comprising:
performing a first authentication step comprising cross-referencing a user-submitted credential of a user against the voter registration records stored in the database to identify a matched voter registration record, the user-submitted credential comprising any one of: a name and address, a voter registration number, a biometric identifier, a government-issued identification document, an email address, or a phone number;
performing, after the first authentication step and as a terminal step of a two-step authentication, a second authentication step comprising determining, using the GPS receiver, that geographic coordinates of a mobile computing device lie within a stored geographic polygon defining a most-acutely-localized voting district associated with the matched voter registration record;
in response to a dual verification of the user by the first authentication step and the second authentication step, auto-populating a user profile with elected official records of one or more voting districts within a voting purview of the user, the voting purview comprising the most-acutely-localized voting district and one or more encompassing legislative districts thereof; and
in response to the dual verification, enabling a district-exclusive verified poll regarding a matter associated with a voting district within the voting purview of the user.

11. The method of claim 10, wherein the most-acutely-localized voting district is selected from a precinct, a ward, a city council district, and a block group.

12. The method of claim 10, further comprising receiving a ternary polling response from the user in connection with the district-exclusive verified poll, the ternary polling response being one of a yay response, a nay response, and an abstain response, and recording the ternary polling response in association with the matter and the voting district within the voting purview of the user.

13. The method of claim 10, wherein the user profile is configured as an anonymous-by-default profile, and wherein, in response to the dual verification, a verified-constituent status of the user is exposed in connection with participation in the district-exclusive verified poll while personally identifiable information of the user is withheld unless the user affirmatively elects to disclose the personally identifiable information.

14. The method of claim 10, further comprising prompting the user to repeat one or both of the first authentication step and the second authentication step at a configurable interval or upon occurrence of a triggering event, the triggering event being selected from expiration of a session token, a change of registered residence in the voter registration records, and a re-installation of a mobile application on the mobile computing device.

15. The method of claim 10, further comprising receiving a hardware-backed attestation from the mobile computing device indicating that the mobile computing device is non-rooted and non-emulated, and conditioning advancement to the second authentication step on receipt of a valid hardware-backed attestation.

16. The method of claim 10, further comprising computing a distance between a first set of the geographic coordinates of the mobile computing device received at a first time and a second set of the geographic coordinates of the mobile computing device received at a second time, computing a velocity by dividing the distance by an elapsed time between the first time and the second time, and conditioning the dual verification on the velocity not exceeding a configurable threshold representing a maximum plausible velocity for human travel.

17. A non-transitory computer-readable medium storing instructions that, when executed by one or more processors of a mobile computing device and one or more processors of a server in networked communication with the mobile computing device, cause the one or more processors to perform operations comprising:
performing a first authentication step comprising cross-referencing a user-submitted credential of a user against voter registration records stored in a database, the voter registration records being indexed by a hashtoken, to identify a matched voter registration record, the user-submitted credential comprising any one of: a name and address, a voter registration number, a biometric identifier, a government-issued identification document, an email address, or a phone number;
performing, after the first authentication step and as a terminal step of a two-step authentication, a second authentication step comprising determining, using a GPS receiver of the mobile computing device, that geographic coordinates of the mobile computing device lie within a stored geographic polygon defining a most-acutely-localized voting district associated with the matched voter registration record;
in response to a dual verification of the user by the first authentication step and the second authentication step, auto-populating a user profile with elected official records of one or more voting districts within a voting purview of the user, the voting purview comprising the most-acutely-localized voting district and one or more encompassing legislative districts thereof; and
in response to the dual verification, enabling a district-exclusive verified poll regarding a matter associated with a voting district within the voting purview of the user.

18. The non-transitory computer-readable medium of claim 17, wherein the second authentication step further comprises comparing an altitude component of the geographic coordinates of the mobile computing device against a configurable upper-bound altitude representing a maximum residential building height for the most-acutely-localized voting district, and conditioning the dual verification on the altitude component not exceeding the configurable upper-bound altitude.

19. The non-transitory computer-readable medium of claim 17, wherein the hashtoken is computed from one or more identifying fields of the matched voter registration record.

20. The non-transitory computer-readable medium of claim 17, wherein auto-populating the user profile comprises retrieving the elected official records from the database and causing the elected official records to be displayed on a display device of the mobile computing device.
